(19) United States
(12) Patent Application Publication
(10) Pub. No.: US 2003/0087196 A1
(43) Pub. Date: May 8, 2003

(54) Resist pattern hardening method

(75) Inventors: Kouichirou Tsujita, Tokyo (JP); Atsumi Yamaguchi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 10/216,816

(22) Filed: Aug. 13, 2002

(30) Foreign Application Priority Data
Nov. 2, 2001 (JP) 2001-337790

(51) Int. Cl. G03C 5/00

(52) U.S. Cl. 430/313; 430/315; 430/322; 430/328

(57) ABSTRACT

A method can improve the etch resistance of a resist pattern and inhibit contraction due to SEM observations. A wafer substrate (1) with a predetermined resist pattern (2) formed thereon is immersed in a solution (10) of an organic substance (11), whereby the organic substance (11) in the solution (10) is introduced into holes (3) in the resist pattern (2). This improves the etch resistance of the resist pattern (2), since carbon generally contributes to improvements in the etch resistance of a resist film. The introduction of the organic substance (11) into the holes (3) can also inhibit contraction due to electron beam radiation involved in SEM observations.

### BACKGROUND OF THE INVENTION

1. Field of the Invention

The present invention relates to a technique for improving a resist pattern's resistance to etching and to SEM (scanning electron microscopy) observations.

2. Description of the Background Art

Recent developments in semiconductor device miniaturization have involved an increasingly shortened wavelength of exposure light for use in the process of forming a photoresist pattern. In the formation of, for example, a resist pattern with minimum dimensions of not more than 130 nm, ArF (193 nm) is used as an exposure light source.

For resolution, resist materials are required to have transparency of about 50% or more to exposure light with their thickness in use. Examples of polymers for ArF resist materials satisfying this condition include an acrylate, a methacrylate, a COMA (CycloOlefin Maleic Anhydride), a cycloolefin and any combination thereof. FIGS. 7A to 7C illustrate examples of these polymers: FIG. 7A shows a methacrylic material; FIG. 7B shows a COMA material; and FIG. 7C shows a polynorbornene material.

Here, the problem is that those polymers have poor etch resistance although they have high transparency. This is an important problem because a resist pattern is required to maintain its shape and dimensions during etching. One solution to this problem, for example in the case of acrylic and methacrylic materials, is to provide protecting groups with high etch resistance on side chains of polymers as shown in FIG. 7A. However, since the protecting groups are generally large in size, a resist film of a resist material provided with protecting groups becomes porous because of its loosely intertwined polymers.

In the case of a COMA material, because of main chains of a complicated structure and high molecular weights of monomers, the number of monomers in polymers is small and a large number of terminals exist. A resist film of a COMA material, like that of an acrylic material, is thus porous. In this fashion, the ArF resist film is porous, which constitutes a factor that causes problems such as deterioration in the etch resistance and contraction of the resist pattern due to electron beam radiation involved in SEM observations.

FIGS. 8A to 8D are diagrams for explaining the problems of a conventional ArF resist, showing the results of etching of an oxide substrate using the ArF resist as a mask. FIG. 8A illustrates the case when no pattern is formed in the resist. In FIGS. 8B to 8D, there is illustrated a resist immediately after etching of the oxide substrate using a hole pattern previously formed in the resist as a mask. FIGS. 8B to 8D show the cases for various ratios of the hole diameter to the hole spacing, 1:4, 1:2, and 1:1, respectively. As can be seen from the drawings, damage to the resist due to etching increases as the hole spacing becomes smaller.

Similarly, FIGS. 9A to 9C are diagrams for explaining the problems of a conventional ArF resist, showing the results of etching of an oxide substrate using the ArF resist as a mask. In FIGS. 9A to 9C, there is illustrated a resist immediately after etching of the oxide substrate using a line pattern previously formed in the resist as a mask. FIGS. 9A to 9C show the cases for various widths of the line pattern, 0.30 μμm, 0.20 μm and 0.14 μm, respectively. As can be seen from the drawings, damage to the resist due to etching increases as the line width decreases.

These results indicate that as the shape of a resist pattern becomes finer, i.e. as the dimensions of a resist become smaller, etching using the resist pattern as a mask causes greater damage to the resist. FIG. 10 is an explanatory diagram of the relationship between the resist dimensions and the etching damage. The reference characters 100a and 100b refer to resists formed on a wafer substrate 110 and the reference numeral 101 illustrates in schematic form the impact of plasma etching of the wafer substrate 110 using the resists 100a and 100b as masks. As shown in the drawing, plasma damage does not reach to a central portion of the resist 100a of relatively large dimensions (e.g., a resist pattern with wide hole spacing or a resist pattern with great line widths), leaving a portion 102 not damaged in the center; therefore, damage to the resist is not critical. On the other hand, plasma damage reaches to a central portion of the resist 100b of small dimensions, which could be critical to the resist. Besides, the central portion of the resist 100b is damaged from both the side faces, which can conceivably accelerate the progress of damage to the resist.

As above described, the ArF resist is porous and its minute holes degrade the etch resistance of the resist. FIG. 11 shows experimental data for a comparison of the numbers of holes in ArF and KrF resists. In this experiment, Ar is implanted into both the Arf and KrF resists. The energy of the Ar ion implantation in a resist destroys parts of the side chains of polymers which form the resist. Although some such destroyed polymers are cross-linked again, the others form a gas and come off the resist film. Thus, contraction occurs in both the ArF and KrF resists. FIG. 11 shows the relationship between the line width of a line pattern in the resist and the amount of contraction. The solid line is the experimental results for the ArF resist and the broken line for the KrF resist. In the drawing, the amount of contraction, which is represented by dimensions, increases with the line width of the resist. According to the observations, the ArF resist contracts by a larger amount than the KrF resist. This result indicates that the ArF resist has a structure with a larger number of holes.

FIG. 12 shows variations in resist width depending on the frequency of SEM observations. In this drawing, the horizontal axis indicates the frequency of SEM observations, each observation being conducted for 120 seconds. The longitudinal axis indicates the measured value of the resist width obtained by the observations. Ordinary SEM observations are conducted with an accelerating voltage of 800 V.

A solid line 110 and a broken line 111 in FIG. 12 show observation results for the ArF resist and the KrF resist, respectively, with an accelerating voltage of 800 V. It can be seen that the dimensions of the ArF resist decrease more drastically with increasing frequency of observations than the dimensions of the KrF resist. This result also indicates that the ArF resist has a structure with a larger number of holes.

To avoid the problem of resist contraction involved in SEM observations, it is contemplated to reduce the accelerating voltage. A solid line 120 and a broken line 121 in FIG. 12 show observation results for the ArF and KrF resists, respectively, with an accelerating voltage of 300 V. It can also be seen from the drawing that the reduced accelerating voltage can inhibit resist contraction. Reducing the accelerating voltage, however, sacrifices the SEM's capacity for observation and is thus not exactly practical.

The above problems are challenges to be solved not only for the ArF resist but also for many other resists having a porous structure.

### SUMMARY OF THE INVENTION

An object of the present invention is to provide a method of hardening a resist pattern that is capable of improving the etch resistance of a resist pattern formed on a wafer and inhibiting contraction involved in SEM observations.

The present invention is directed to a method of hardening a porous resist pattern having holes formed therein. This method includes the steps of: (a) forming the resist pattern on a wafer; and (b) introducing a predetermined to-be-introduced substance containing at least carbon into the holes in the resist pattern.

The method according to the invention can thus improve the etch resistance of the resist pattern and inhibit contraction in SEM observations.

Preferably, in the method, the to-be-introduced substance is an organic substance, and the step (b) includes the step of immersing the resist pattern in a solution of the organic substance.

This allows an introduction of the organic substance into the holes in the resist pattern, thereby improving the etch resistance of the resist pattern and inhibiting contraction in SEM observations.

Preferably, in the method, the to-be-introduced substance is an organic substance, and the step (b) includes the step of applying a solution of the organic substance to the resist pattern.

This allows an introduction of the organic substance into the holes in the resist pattern, thereby improving the etch resistance of the resist pattern and inhibiting contraction in SEM observations.

Preferably, in the method, the resist pattern is formed of a chemically amplified resist, the step (a) includes the step of exposing the chemically amplified resist, and the solution of the organic substance contains a crosslinker which bonds the resist pattern and the organic substance together, using acid as a catalyst.

In this case, acid generated at the exposure of the chemically amplified resist becomes a catalyst and the crosslinker provides a bond between the organic substance and the resist pattern. This further improves the etch resistance of the resist pattern.

Preferably, in the method, the to-be-introduced substance is an organic substance, and the step (b) includes the step of exposing the resist pattern to a vapor of the organic substance.

This allows an introduction of the organic substance into the holes in the resist pattern, thereby improving the etch resistance of the resist pattern and inhibiting contraction in SEM observations. Exposing the resist pattern to a vapor of the organic substance also has the advantage of allowing a more efficient introduction of the organic substance in the step (b) than directly applying the solution of the organic substance to the resist pattern.

Preferably, in the method, the to-be-introduced substance is a low molecular organic substance.

The low molecular organic substance is apt to penetrate into porous portions of the resist pattern, which allows an efficient introduction of the organic substance into the holes.

Preferably, in the method, the to-be-introduced substance is a phenolic organic substance.

The phenolic organic substance contains a benzene ring and has high etch resistance, thereby considerably improving the etch resistance of the resist pattern.

Preferably, in the method, the to-be-introduced substance is a gas of either an organic substance or an inorganic carbon compound, and the step (b) includes the step of raising a pressure of the gas after exposing the wafer with the resist pattern formed thereon to an atmosphere of the gas.

This allows an introduction of the organic substance into the holes in the resist pattern, thereby improving the etch resistance of the resist pattern and inhibiting contraction in SEM observations.

Preferably, in the method, the to-be-introduced substance is a substance to be an ion source, and the step (b) includes the step of ion implanting the to-be-introduced substance into the resist pattern.

The ion implantation introduces the organic substance into the holes in the resist pattern, thereby improving the etch resistance of the resist pattern and inhibiting contraction in SEM observations.

Preferably, the method further includes the step of: (c) subsequent to the step (b), providing electron beam radiation to the resist pattern.

This provides bonds between the resist pattern and the to-be-introduced substance introduced into the holes in the resist pattern and between each of the to-be-introduced substances and recreates crosslinks between resist polymers, thereby further improving the etch resistance of the resist pattern. Further, the presence of the to-be-introduced substance in the holes reduces the amount of reduction in the volume of the resist pattern due to the electron beam radiation.

Preferably, the method further includes the step of: (d) subsequent to the step (b), performing ion implantation on the resist pattern.

This provides bonds between the resist pattern and the to-be-introduced substance introduced into the holes in the resist pattern and between each of the to-be-introduced substances and recreates crosslinks between resist polymers, thereby further improving the etch resistance of the resist pattern. Further, the presence of the to-be-introduced substance in the holes reduces the amount of reduction in the volume of the resist pattern due to the electron beam radiation.

Preferably, in the method, the step (b) includes the step of controlling the type and amount of the to-be-introduced substance to adjust dimensions of the resist pattern.

This allows fine adjustments of the dimensions of the resist pattern, thereby contributing to improvements in dimensional accuracy of the resist pattern.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram illustrating the process of immersing a wafer in a solution of an organic substance in a method of hardening a resist pattern according to a first preferred embodiment;

FIG. 2 is a schematic diagram showing that the organic substance is introduced into holes in the first preferred embodiment;

FIGS. 3A to 3D are diagrams showing examples of the organic substance for use in the first preferred embodiment;

FIG. 4 is a diagram showing an example of a crosslinker for use in a second preferred embodiment;

FIG. 5 is a diagram showing the general formula for crosslinking reaction in the second preferred embodiment;

FIG. 6 is a diagram illustrating in schematic form one of the holes after crosslinking reaction in the second preferred embodiment;

FIGS. 7A to 7C are diagrams showing examples of a conventional ArF resist material;

FIGS. 8A to 8D are diagrams for explaining the problems of a conventional ArF resist material;

FIGS. 9A to 9C are diagrams for explaining the problems of a conventional ArF resist material;

FIG. 10 is a diagram for explaining the relationship between the resist dimensions and the etching damage;

FIG. 11 is a diagram showing experimental data for a comparison of the numbers of holes in ArF and KrF resists; and

FIG. 12 is a diagram showing variations in resist width depending on the frequency of SEM observations.

### DESCRIPTION OF THE PREFERRED EMBODIMENTS

<First Preferred Embodiment>

This preferred embodiment tries to achieve resist hardening by introducing organic substances into minute holes in a porous resist. Hereinbelow, a method of hardening a resist according to this preferred embodiment will be set forth.

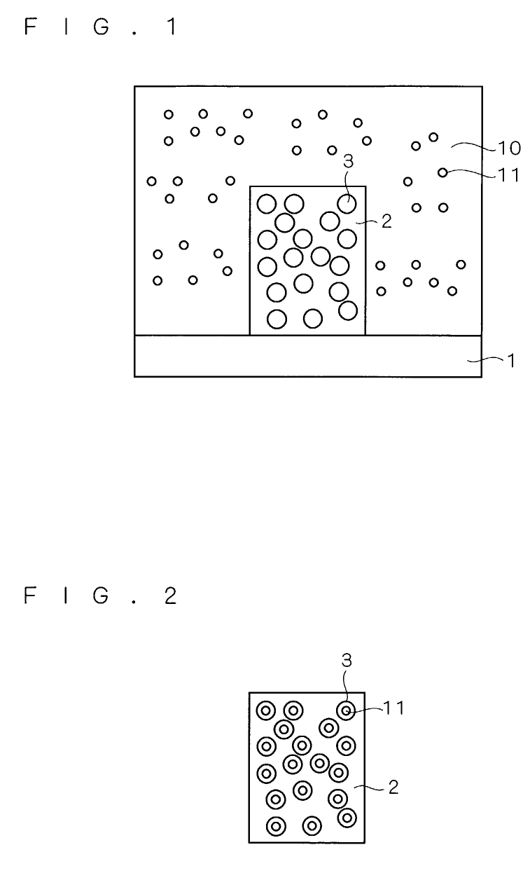

First, a predetermined resist pattern is formed on a wafer substrate. The wafer with the resist pattern formed thereon is then immersed in a solution of organic substances (e.g., an operation process equivalent to dip development), whereby the organic substances in the solution are introduced into holes in the resist pattern. FIG. 1 is a schematic diagram showing that a wafer is immersed in a solution of organic substances. In the drawing, the reference numeral 1 designates a wafer substrate; the reference numeral 2 designates a resist pattern formed on the wafer substrate; and the reference numeral 3 designates a hole in the resist pattern 2. The reference numeral 10 designates a solution of organic substances to be introduced into the holes 3 in the resist pattern 2, and the reference numeral 11 designates such an organic substance.

Through this process, the solution 10 penetrates and the organic substances 11 are introduced into the holes 3 in the resist pattern 2. FIG. 2 is a schematic diagram showing that the organic substances 11 are introduced into the holes 3. In this drawing, for the sake of simplicity of explanation, only one molecule of the organic substances 11 is illustrated in each of the holes 3, but it should be understood that in practice, a plurality of molecules of the organic substances 11 may be introduced into each one of the holes 3.

It should also be understood that the process for introducing the organic substances 11 into the holes 3 in the resist pattern 2 is not limited to the embodiment shown and described. For example, the solution 10 of the organic substances 11 may be applied to the wafer 1 having the resist pattern 2 formed thereon, by spin coating at a low speed of from zero to about several tens rpm and subsequent spinning stop (e.g., an operation process equivalent to a puddle development process). In this case also, as shown in FIG. 2, the solution 10 penetrates and the organic substances 11 are introduced into the holes 3 in the resist pattern 2.

The wafer 1 immersed in the solution 10 is then taken out of the solution 10. Or, the remaining solution 10 which was applied but did not penetrate into the resist pattern 2 is driven off by spinning.

By the above processes, the organic substances 11 are introduced into the holes 3 which are porous portions of the resist pattern 2, whereby degradation in the etch resistance due to the porosity of the resist pattern 2 is inhibited. That is, the etch resistance of the resist pattern 2 is improved. It is obvious that the presence of the organic substances 11 in the holes 3 also inhibits contraction due to electron beam radiation involved in SEM observations.

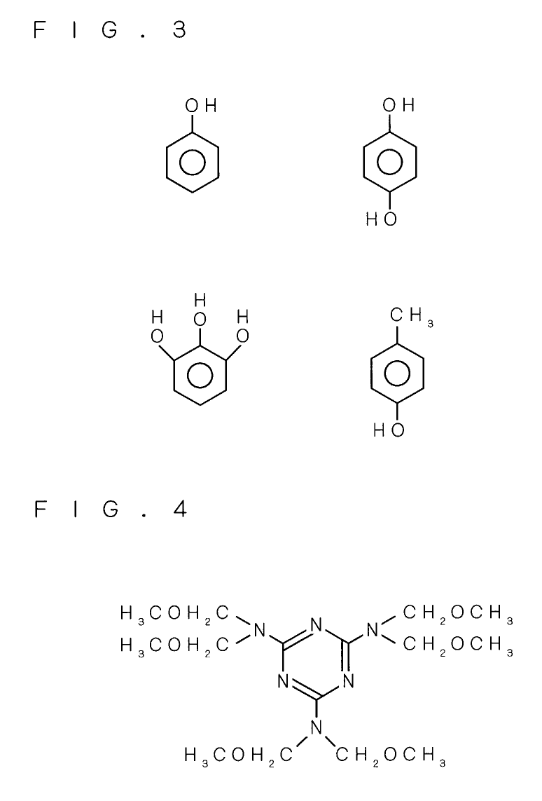

Here, the organic substances 11 to be introduced into the holes 3 need to be low molecular substances to readily penetrate into the porous portions of the resist pattern 2. One example of this is phenolics. More specifically, examples include phenols, hydroquinone, pyrogallol, and cresols as shown in FIG. 3 and isomers thereof. Especially these substances contain a benzene ring and are known to have high etch resistance.

The concentration of the solution 10 of the organic substances 11 may be 100%, for example when the to-be-introduced substances themselves are liquids such as phenols described above. If the solution 10 needs to be diluted for the purposes of safety in operation and cost reduction, dilution up to about 10% is possible. A dilution solvent for use in that case is required to have the characteristics of dissolving the organic substances 11 but not dissolving the resist pattern 2. Examples of this include water, hexane, toluene, and IPA. The temperature of the solution 10 is preferably high at the penetrating surface of the resist pattern 2 but it may be set to about room temperatures (about 25° C.) in consideration of safety and convenience in operation.

As above described, the introduction of the organic substances 11 into the holes 3 is basically accomplished by causing the solution 10 to penetrate into the porous portions of the resist pattern 2 by capillarity, and the time required for the penetration is about several seconds. Thus, several seconds will be ample for an immersion time of the wafer 1 in the solution 10 (an application time of the solution 10 to the wafer 1). However, as long as the immersion (application) is performed within cycle time in conventional various photolithography processes, it involves no degradation in processing capability throughout the photolithography processes. From this, there are no problems even if the immersion time of the wafer 1 in the solution 10 is set to about one minute to achieve the effect of the present invention with stability.

When the resist pattern 2 is large in shape, complete penetration of the solution 10 into the resist pattern 2 may be difficult. However, since the thickness of the resist to wear during etching is usually in the range of 200 to 400 nm, a sufficient effect can be achieved if the solution 10 penetrates into the surface to a depth that is roughly equivalent to the amount of wearing.

To facilitate the introduction of the organic substances 11 into the resist pattern 2, it is further contemplated to increase the amount of the solvent remaining in the resist pattern 2 after patterning. This is accomplished for example by reducing the temperatures of post-resist-application baking and post exposure baking to such an extent as not to degrade resolution. The optimum temperatures of those baking vary depending on the type of the resist, but in general a reduction of about 20° C. in temperature involves no degradation in the resolution.

Moreover, since few portions of the resist film even with a low level of porosity are complete shields and thus, the resist film as a whole is porous to some extent, controlling processing conditions allows the organic substances to be introduced deeply into the resist. In that case also a large amount of organic substances are introduced into highly porous portions of the resist.

<Second Preferred Embodiment>

While, as above described, the introduction of the organic substances 11 into the holes 3 which are the porous portions of the resist pattern 2 improves the etch resistance of the resist pattern 2 and inhibits contraction due to electron beam radiation in SEM observations, the effect of improving the etch resistance of the resist pattern 2 can further be increased by bonding the organic substances with polymers (resist polymers) forming the resist.

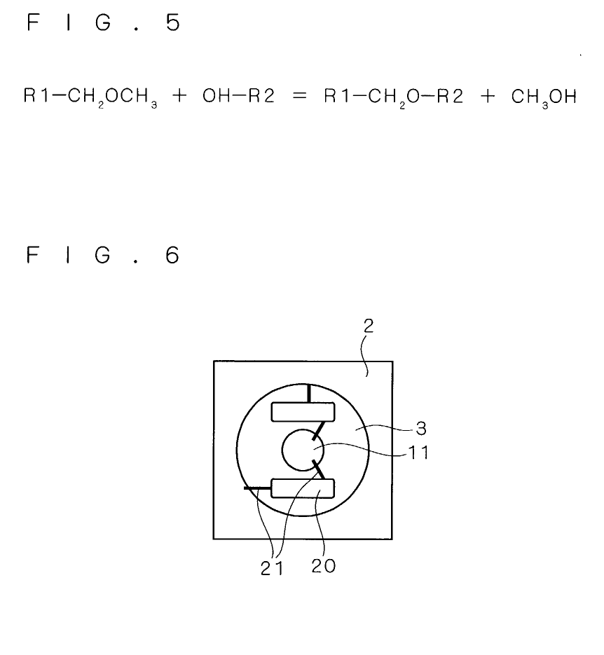

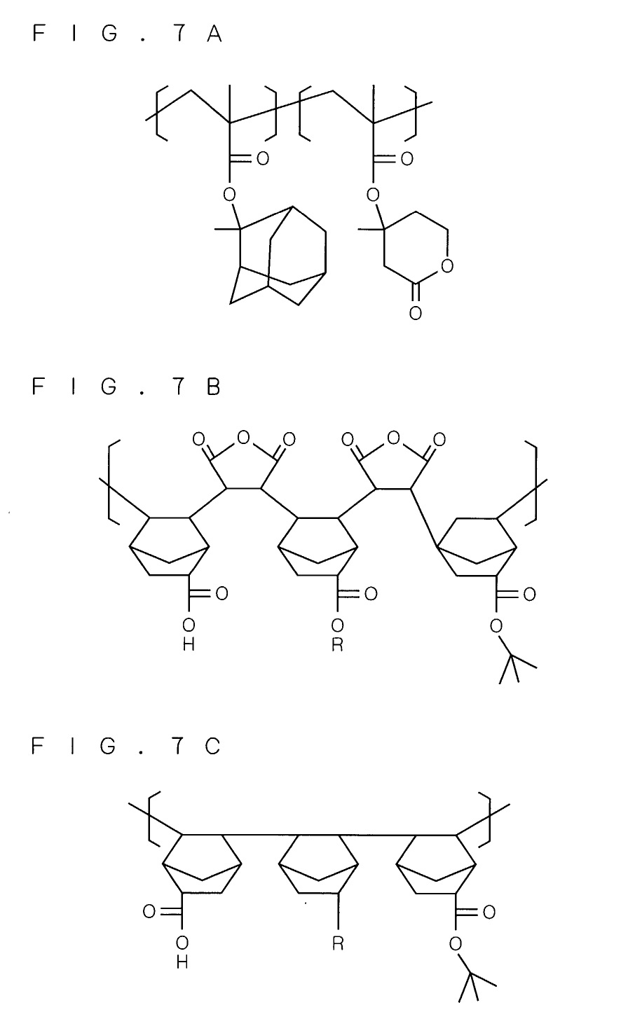

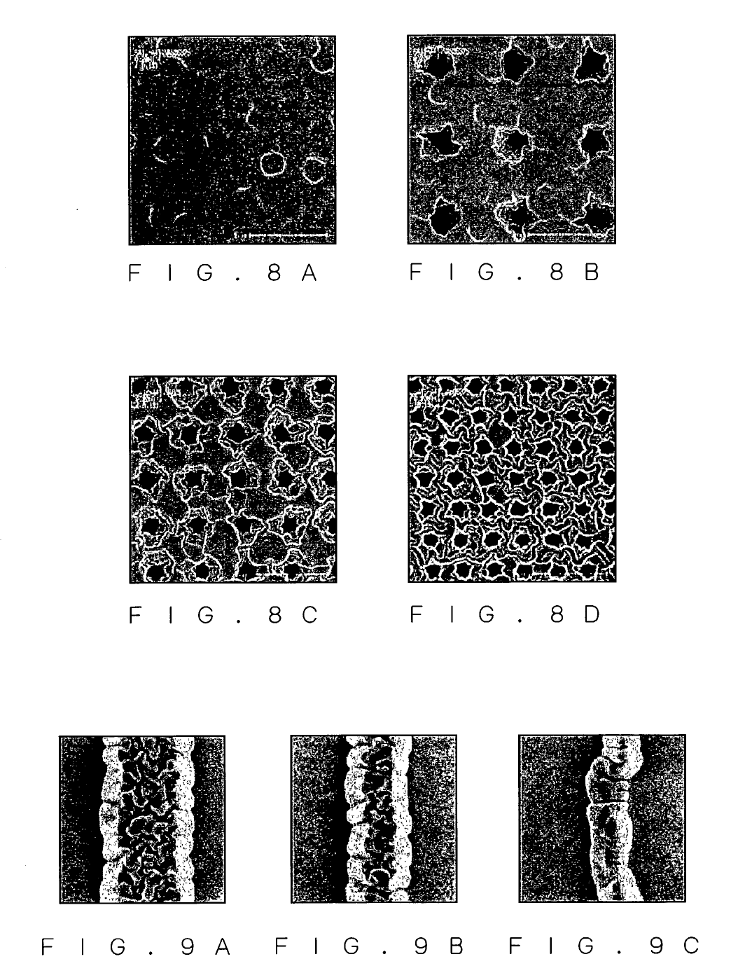

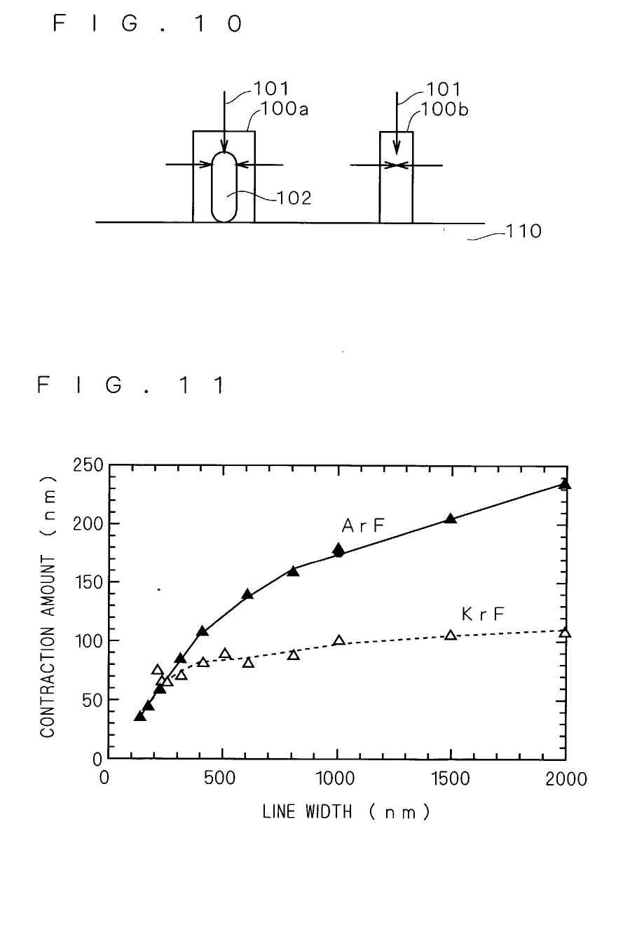

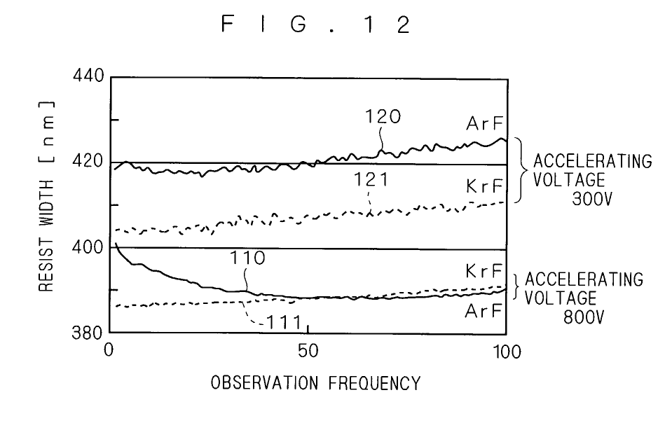

In this preferred embodiment, crosslinkers as well as the organic substances 11 are introduced into the holes 3 which are the porous portions of the resist pattern 2. One example of the crosslinkers is a melamine crosslinker shown in FIG. 4. The wafer 1 with the resist pattern 2 formed thereon is immersed in a solution of the crosslinkers and the organic substances 11 (or such a solvent is applied to the wafer 1), whereby the organic substances 11 and the crosslinkers are introduced into the holes 3 in the resist pattern 2.

The solvent of the crosslinkers and the organic substances 11 is required to have the characteristics of dissolving the organic substances 11 but not dissolving the resist pattern 2. Examples of this include water, hexane, toluene, and IPA.

In this preferred embodiment, the resist film forming the resist pattern 2 is a chemically amplified resist. The chemically amplified resist includes an acid generator as a photosensitive agent and thus, generates acid by being exposed to light. If the resist film is a negative type chemically amplified resist, portions remaining as the resist pattern 2 are exposed portions of the resist, where acid generated by exposure remains. The presence of the acid provides bonds of the organic substances 11, the crosslinkers, and the resist polymers in the holes 3 in the resist pattern 2. FIG. 5 shows the general formula for chemical reaction (crosslinking reaction) involved in the bonding. For example, as shown in the drawing, the side chains of melamine are bonded to hydroxyl groups in the presence of the acid. Since the resist contains hydroxyls and carboxyls and the organic substances 11, such as phenols, introduced into the holes 3 contain hydroxyls, both the resist and the organic substances 11 can react with the crosslinkers.

FIG. 6 schematically shows one of the holes 3 in the resist pattern 2 after the above reaction. In the drawing, the reference numeral 20 designates a crosslinker introduced into the holes 3 along with the organic substances 11. The chemical reaction expressed in FIG. 5 provides bonds between the organic substances 11 and the polymers forming the resist pattern 2 via the crosslinkers 21. This bonding further improves the etch resistance of the resist pattern 2 than in the first preferred embodiment.

If, in this preferred embodiment, the resist film is a positive type chemically amplified resist, the resist pattern 2 is formed of unexposed portions of the resist and thus contains only an extremely small quantity of acid that was diffused from the exposed portions of the resist. At this time, the crosslinking reaction may not sufficiently proceed. In such a case, after the formation of the resist pattern 2, the whole wafer surface should be subjected to the exposure process to such an extent as to generate sufficient acid for crosslinking reaction.

<Third Preferred Embodiment>

In this preferred embodiment, the bonds between the organic substances 11 introduced into the holes 3 in the resist pattern 2 and the resist polymers are provided by EB (electron beam) radiation. In this case, no crosslinkers are needed, and additionally, the organic substances 11 do not necessarily have to contain hydroxyl groups. This brings the advantage of extending the range of choices for the organic substances 11.

In the present example, only EB radiation of the resist pattern 2 without the introduction of the organic substances 11 into the holes 3 can accomplish decomposition and reestablishment of the bonds between the resist polymers, which improves the etch resistance of the resist pattern 2. This, however, involves a reduction in the volume of the resist pattern 2. In this preferred embodiment, the presence of the organic substances 11 in the holes 3 can reduce the amount of such a reduction in volume. That is, the presence of the organic substances 11 in the holes 3 can reduce the amount of reduction in volume caused by EB radiation of the resist pattern 2 and can further improve the etch resistance of the resist pattern 2 than in the first preferred embodiment.

<Fourth Preferred Embodiment>

In this preferred embodiment, the bonds between the organic substances 11 introduced into the holes 3 in the resist pattern 2 and the resist polymers are provided by ion implantation. In this case, no crosslinkers are needed, and additionally, the organic substances 11 do not necessarily have to contain hydroxyl groups. This brings the advantage of extending the range of choices for the organic substances 11.

In the present example, only ion implantation into the resist pattern 2 without the introduction of the organic substances 11 into the holes 3 can accomplish decomposition and reestablishment of the bonds between the resist polymers, which improves the etch resistance of the resist pattern 2. This, however, involves a reduction in the volume of the resist pattern 2. In this preferred embodiment, the presence of the organic substances 11 in the holes 3 can reduce the amount of such a reduction in volume. That is, the presence of the organic substances 11 in the holes 3 can reduce the amount of reduction in volume due to ion implantation and can further improve the etch resistance of the resist pattern 2 than in the first preferred embodiment.

<Fifth Preferred Embodiment>

Depending on the combination of the organic substances 11 and the resist material, the bonds between the organic substances 11 and the resist polymers may be difficult to establish. In this preferred embodiment, therefore, a plurality of molecules of the organic substances 11 introduced into each one of the holes 3 are bonded together for polymerization.

As a technique for the bonding, it is contemplated to use EB radiation or ion implantation, for example. In general, polymers with molecular weights of up to about 10,000 are known to have higher etch resistance with increasing molecular weights and their etch resistance is improved by bonding molecules of the organic substances 11 in the minute holes 3 for polymerization. Thereby the etch resistance of the resist pattern 2 is further improved than in the first preferred embodiment.

At this time, the presence of the organic substances 11 in the holes 3 can reduce the amount of reduction in the volume of the resist pattern 2 due to EB radiation or ion implantation.

<Sixth Preferred Embodiment>

As the process for introducing the organic substances 11 into the holes 3 in the resist pattern 2, the first preferred embodiment has shown the technique for immersing the wafer 1 in the solution 10 of the organic substances 11 or the technique for applying the solution 10 of the organic substances 11 to the wafer 1. Such a technique is to bring the solution 10, i.e., a liquid, in direct contact with the resist pattern 2.

When the solution 10 of the organic substances 11 and the resist pattern 2 are in contact, however, the surface tension of the solution 10 may prevent the solution 10 from being introduced into the holes 3. In this preferred embodiment, therefore, when the organic substances 11 themselves are liquids under normal conditions, they are evaporated and the wafer 1 with the resist pattern 2 formed thereon is exposed to vapors thereof. This allows an efficient introduction of the organic substances 11 into the holes 3 in the resist pattern 2.

<Seventh Preferred Embodiment>

This preferred embodiment employs a gas as substances to be introduced into the holes 3. One example of such organic substances is methane. Inorganic substances such as CO2 can also be considered as an example, which extends the range of choices for the substances to be introduced.

As a way of introduction, the wafer 1 with the resist pattern 2 formed thereon and a gas to be introduced are housed in an airlock and the pressure of the introduced gas is raised. Thereby, the substances to be introduced are introduced into the holes 3.

Another way is to introduce to-be-introduced substances into a chamber before main etching in the etching process and then to purge an atmosphere of the introduced substances for the normal etching process. This technique imposes a restriction that only pressures within a range usable by an etcher are applicable but has the advantage of eliminating the need for a special airlock.

<Eighth Preferred Embodiment>

In this preferred embodiment, substances which contain carbon and are to be ion sources are employed as substances to be introduced and are introduced into the holes 3 by ion implantation. Examples of such substances include carbon itself and carbon dioxide. Since carbon generally contributes to improvements in the etch resistance, the etch resistance of the resist pattern 2 can be improved.

When it is necessary to further improve the etch resistance, additional EB radiation or ion implantation, as in the aforementioned fifth preferred embodiment, may be performed after the introduction of the to-be-introduced substances. This strengthens the bonds between the introduced substances and the resist, thereby further improving the etch resistance.

<Ninth Preferred Embodiment>

When the substances to be introduced into the holes 3 in the resist pattern 2 increase in volume, the volume of the resist pattern 2 increases as a matter of course. The amount of increase varies depending on the type and amount of the substances to be introduced. This indicates that the dimensions of the resist pattern 2 can be adjusted by controlling the type and amount of the substances to be introduced.

In this preferred embodiment, therefore, the type and amount of the substances to be introduced are controlled to adjust the dimensions of the resist pattern 2. Usually it is unnecessary to introduce into the holes 3 more substances than necessary to improve the etch resistance, but in the present example, the amount and type of the substances to be introduced are determined for adjustment of the pattern dimensions. This allows fine adjustments of the dimensions of the resist pattern 2, thereby contributing to improvements in the precision of etching and in the dimensional accuracy of the resist pattern 2.

For example when etching causes a reduction in dimension, it is effective to increase initial dimensions of the resist. This is especially effective, for example, at forming minute holes.

Now, it goes without saying that the present invention is not limited only to the application to the aforementioned ArF resist pattern but applicable to any resist pattern having a porous structure with similar effects.

While the invention has been shown and described in detail, the foregoing description is in all aspects illustrative and not restrictive. It is therefore understood that numerous modifications and variations can be devised without departing from the scope of the invention.

What is claimed is:

1. A method of hardening a porous resist pattern having holes formed therein, comprising the steps of:
(a) forming said resist pattern on a wafer; and
(b) introducing a predetermined to-be-introduced substance containing at least carbon into said holes in said resist pattern.

2. The method according to claim 1, wherein
said to-be-introduced substance is an organic substance, and
said step (b) includes the step of immersing said resist pattern in a solution of said organic substance.

3. The method according to claim 1, wherein
said to-be-introduced substance is an organic substance, and
said step (b) includes the step of applying a solution of said organic substance to said resist pattern.

4. The method according to claim 2, wherein
said resist pattern is formed of a chemically amplified resist,
said step (a) includes the step of exposing said chemically amplified resist, and
said solution of said organic substance contains a crosslinker which bonds said resist pattern and said organic substance together, using acid as a catalyst.

5. The method according to claim 3, wherein
said resist pattern is formed of a chemically amplified resist,
said step (a) includes the step of exposing said chemically amplified resist, and
said solution of said organic substance contains a crosslinker which bonds said resist pattern and said organic substance together, using acid as a catalyst.

6. The method according to claim 1, wherein
said to-be-introduced substance is an organic substance, and
said step (b) includes the step of exposing said resist pattern to a vapor of said organic substance.

7. The method according to claim 1, wherein
said to-be-introduced substance is a low molecular organic substance.

8. The method according to claim 1, wherein
said to-be-introduced substance is a phenolic organic substance.

9. The method according to claim 1, wherein
said to-be-introduced substance is a gas of either an organic substance or an inorganic carbon compound, and
said step (b) includes the step of raising a pressure of said gas after exposing said wafer with said resist pattern formed thereon to an atmosphere of said gas.

10. The method according to claim 1, wherein
said to-be-introduced substance is a substance to be an ion source, and
said step (b) includes the step of ion implanting said to-be-introduced substance into said resist pattern.

11. The method according to claim 1, further comprising the step of:
(c) subsequent to said step (b), providing electron beam radiation to said resist pattern.

12. The method according to claim 1, further comprising the step of:
(d) subsequent to said step (b), performing ion implantation on said resist pattern.

13. The method according to claim 1, wherein
said step (b) includes the step of controlling the type and amount of said to-be-introduced substance to adjust dimensions of said resist pattern.
